(19) United States
(12) Patent Application Publication
(10) Pub. No.: US 2009/0218496 A1
(43) Pub. Date: Sep. 3, 2009

(54) SENSING APPARATUS AND A METHOD OF DETECTING SUBSTANCES

(75) Inventor: Toshihito KIMURA, Ashigara-kami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/391,768

(22) Filed: Feb. 24, 2009

(30) Foreign Application Priority Data
Feb. 28, 2008 (JP) 2008-047616

(51) Int. Cl. G01J 1/58

(52) U.S. Cl. 250/362; 250/363.01

(57) ABSTRACT

A sensing apparatus comprises: a prism; a metal film provided on a surface of the prism and which has provided on its surface a material that binds to an analyte; a substrate that is provided on a surface of the prism and which has formed therein a channel for supplying a liquid sample to the metal film; a light source for issuing light; an optical unit for incident light by which the light issued from the light source is launched into the prism at a specified angle; a light detecting unit for detecting as a first detection signal the light being generated in neighborhood of the metal film before the liquid sample is supplied and for detecting as a second detection signal the light being generated in neighborhood of the metal film that has become dry after the liquid sample is supplied; and an analyte detection unit for detecting the analyte contained in the liquid sample based on a difference between the first and the second detection signals detected by the light detecting unit.

The entire contents of documents cited in this specification are incorporated herein by reference.

### BACKGROUND OF THE INVENTION

The present invention relates to a sensing apparatus that detects analytes in a liquid sample with the aid of an enhanced field created by allowing light to strike a detection surface at a specified angle of incidence, and a method of detecting substances with the aid of an enhanced field created by allowing light to strike a detection surface at a specified angle of incidence.

Known as a method that can be used in bio-measurement (measurement of reactions in biomolecules) and the like to detect (or measure) analytes with high sensitivity and great ease is fluorometry in which fluorescence from a fluorescent material that is excited by light at a specified wavelength to emit fluorescence (i.e., a fluorescence emitting material) is detected to thereby detect (or measure) the analytes.

If the analytes in fluorometry are a fluorescent material, a sample of interest that is assumed to contain the analytes is irradiated with exciting light at a specified wavelength and the resulting emission of fluorescence is detected to verify the presence of the analytes.

Even if the analytes in fluorometry are not a fluorescent material, a specifically binding material, or a material that specifically binds to the analytes is labeled with a fluorescent material and then bound to the analytes; subsequently, the same procedure as described above is performed to detect fluorescence (specifically, the fluorescence from the fluorescent material with which the specifically binding material that has bound to the analytes is labeled), whereby the presence of the analytes is verified.

Here, it has been proposed that the sensitivity of analyte detection in fluorometry be increased by exciting the fluorescent material with the aid of an enhanced electric field that results from surface plasmon resonance on a metal film (see, for example, JP 2002-62255 A, JP 2001-21565 A, and JP 2002-257731 A).

In each of the methods described in those patent documents, analytes labeled with a fluorescent material are positioned in the neighborhood of a thin metal film and light is allowed to strike the boundary surface between the thin metal film and a prism (either a semicylindrical or triangular glass prism) at an angle that satisfies the plasmon resonance condition (plasmon resonance angle) to create an enhanced electric field on the thin metal film so that the analytes in the neighborhood of the thin metal film are excited strong enough to amplify the emission of fluorescence from the fluorescent material. This is a method of fluorescence detection utilizing the surface plasmon enhanced fluorescence (which is hereinafter sometimes abbreviated as SPF).

As descried in JP 2001-21565 A, the electric field of surface plasmons is highly localized on the metal surface and attenuates exponentially with the distance from the metal surface, so fluorescently labeled antibodies (i.e., the fluorescent material) adsorbed onto the metal surface can be excited selectively and with high probability. As also described in JP 2001-21565 A, this SPF-based version of fluorescence detection ensures that the effect of any interfering material that is distant from the interface is suppressed to the smallest level, which also allows for precise detection of the analytes.

### SUMMARY OF THE INVENTION

A problem with the detection of fluorescence from the fluorescent material in fluorometry is that the measured value includes extraneous light other than the fluorescence from the fluorescent material, as exemplified by endogenous fluorescence from various parts of the detector system such as the container, the liquid sample and the optical unit, the exciting light from the metal film that has passed through the filter in the light receiving optical unit without being cut off, and the electric noise from the sensing unit.

To deal with this problem of fluorometry, those noise components are cut off by baseline subtraction. Specifically, the fluorescence that is emitted before the analytes labeled with the fluorescent material are positioned on the metal film (which is hereinafter sometimes referred to as the detection surface), this is, the light issued from the surface of the metal film, is measured as detection signal P0 whereas the fluorescence emitted after the analytes are positioned on the detection surface is measured as detection signal P, and a difference Δ=P−P0 is detected as a noise-free fluorescence signal from the fluorescent material with which the analytes are labeled.

Generally speaking, the detection surface at the time when P0 is measured (i.e., before the analytes are positioned on the detection surface) is in contact with the air only whereas the detection surface at the time when P is measured (i.e., as the analytes labeled with the fluorescent material are positioned on the detection surface) is filled with the liquid sample. In addition, the refractive index of the detection surface varies greatly depending on whether it has a liquid on it or not, so the refractive index of the detection surface changes a lot between the measurements of P0 and P and the difference dn may be as great as 0.3.

A further problem with the SPF-based method of detecting fluorescence is that the plasmon resonance condition and, hence, the plasmon resonance angle varies with the refractive index at the surface of the thin metal film; this means that a great change in the refractive index at the surface of the thin metal film is accompanied by a correspondingly great change in the plasmon resonance angle.

Accordingly, the plasmon resonance angle changes a lot between the measurements of P0 and P. For example, if the refractive index changes by 0.3, the plasmon resonance angle varies by about 20 degrees.

As a result, even if light of the same wavelength is allowed to be incident at the same angle in the measurements of P0 and P, no plasmon resonance occurs, nor does the surface plasmon enhancing effect. Thus, baseline subtraction that is performed on the basis of P0 and P measurements made under the same conditions is incapable of correct noise removal since the intensity of the enhanced electric field created on the metal film is different and so is the state of light emission.

The surface plasmon enhancing effect can be created by changing the incident angle and wavelength of the exciting light between the measurements of P0 and P but, then, a system configuration that enables the incident angle and wavelength of the exciting light to be adjusted in accordance with the variation in refractive index results in a complex and expensive apparatus.

As a further problem, given the great difference in plasmon resonance angle, changes in the wavelength and incident angle will cause a corresponding change in noise and, obviously, baseline subtraction that is performed on the basis of P0 and P measurements made under different conditions is incapable of correctly removing the noise as occurs during the measurement.

As mentioned above, baseline subtraction cannot be performed if the detection surface remains dry during P0 measurement, so one might think of wetting the detection surface with a buffer solution before starting the P0 measurement. However, the buffer solution is a cost increasing factor. What is more, a refractive index difference between the buffer solution and the liquid sample containing the analytes again causes a change in the plasmon resonance condition and, hence, in the degree by which the emission of fluorescence is enhanced; this lack of quantitativeness makes it impossible to achieve correct noise removal.

As a further problem, noise varies with a number of factors including the type of the liquid sample, its state, concentration, the thickness of the thin metal film, and the shape of the prism, so it is impossible to correctly remove the noise as occurs during the measurement even if data on the preliminarily measured sample is used.

These difficulties are in no way limited to the case of detecting analytes with the aid of an electric field created by surface plasmons; similar problems occur in the case of using the detection method in which the degree of enhancement varies with the refractive index of the detecting section.

An object, therefore, of the present invention is to solve the aforementioned problems with the prior art by providing a sensing apparatus that enables correct baseline subtraction to ensure that the analytes in a liquid sample can be detected with high precision.

Another object of the present invention is to provide a method of detecting substances characterized in that it enables correct baseline subtraction to ensure that the analytes in a liquid sample can be detected with high precision.

A sensing apparatus according to the invention comprises: a prism; a metal film provided on a surface of the prism and which has provided on its surface a material that binds to the analyte; a substrate that is provided on a surface of the prism and which has formed therein a channel for supplying the liquid sample to the metal film; a light source for issuing light; an optical unit for incident light by which the light issued from the light source is launched into the prism at a specified angle; a light detecting means for detecting as a first detection signal the light being generated in neighborhood of the metal film before the liquid sample is supplied and for detecting as a second detection signal the light being generated in neighborhood of the metal film that has become dry after the liquid sample is supplied; and an analyte detection means for detecting the analyte contained in the liquid sample based on a difference between the first and the second detection signals detected by the light detecting means.

A method of detecting substances according to the invention comprises: a metal film providing step in which a metal film having on a surface thereof a specifically binding material that specifically binds to an analyte is provided; a first light-detecting step in which when another surface of the metal film is irradiated with light at a specified angle of incidence as the surface of the metal film is not in contact with a liquid sample so as to generate an enhanced field on the surface of the metal film, the light being generated in neighborhood of the surface of the metal film is detected as a first detection signal; a liquid sample feeding step in which the liquid sample is allowed to pass over the metal film so that the surface of the metal film is brought into contact with the liquid sample;

a second light-detecting step in which when another surface of the metal film is irradiated with light at the specified angle of incidence as the surface of the metal film has become dry after it was contacted by the liquid sample so as to generate an enhanced field on the surface of the metal film, the light being generated in neighborhood of the surface of the metal film is detected as a second detection signal; and a substance detecting step in which the analyte in the liquid sample is detected from the difference between the first detection signal and the second detection signal.

### BRIEF DESCRIPTION OF THE DRAWINGS

FIG. 1 is a block diagram showing a general construction of an embodiment of the sensing apparatus of the present invention;

FIG. 2A is a top view showing a general layout of a light source, an optical unit for incident light, and a probe chip in the sensing apparatus shown in FIG. 1;

FIG. 2B is a section of FIG. 2A taken along line B-B;

FIG. 3 is an enlarged schematic view showing enlarged a part of the metal film on the probe chip shown in FIGS. 2A and 2B;

FIGS. 4A to 4D are illustrations showing how a liquid sample flows in the probe chip;

FIG. 5 is an enlarged schematic view showing enlarged a part of the metal film with the liquid sample having reached it;

FIG. 6 is a block diagram showing a general construction of another embodiment of the sensing apparatus of the present invention;

FIG. 7 is a block diagram showing a general construction of yet another embodiment of the sensing apparatus of the present invention; and

FIG. 8 is a block diagram showing a general construction of still another embodiment of the sensing apparatus of the present invention.

### DESCRIPTION OF THE PREFERRED EMBODIMENTS

The sensing apparatus and the method of detecting substances according to the present invention are described below in detail by referring to the embodiments shown in the accompanying drawings.

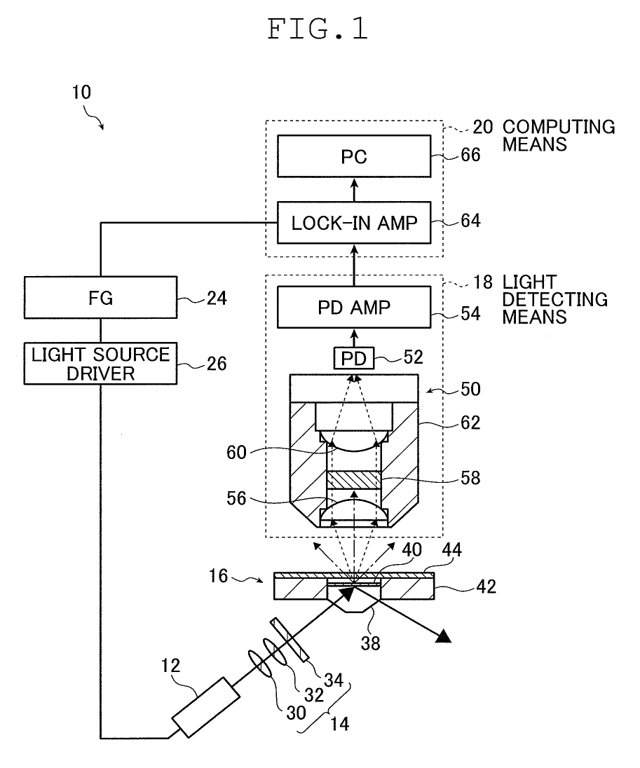

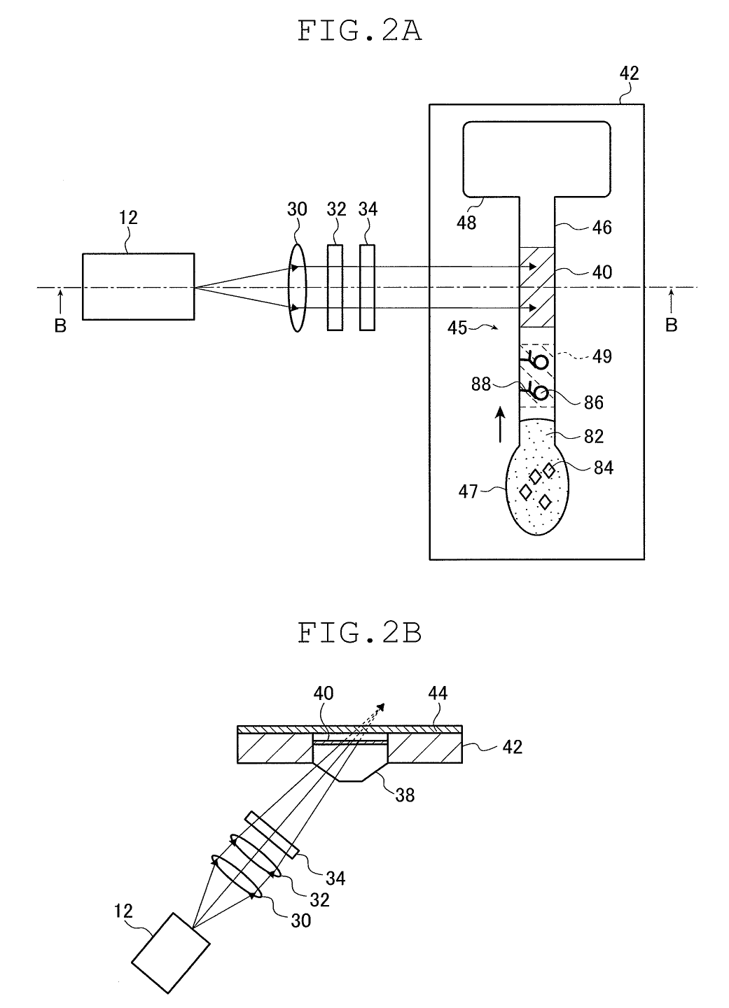

FIG. 1 is a block diagram showing a general construction of a sensing apparatus 10 which is an embodiment of the sensing apparatus of the present invention; FIG. 2A is a top view showing a general layout of a light source 12, an optical unit for incident light 14, and a probe chip 16 in the sensing apparatus 10 shown in FIG. 1; and FIG. 2B is a section of FIG. 2A taken along line B-B.

As shown in FIG. 1 as well as in FIGS. 2A and 2B, the sensing apparatus 10 comprises basically the light source 12 that issues light of a specified wavelength, the optical unit for incident light 14 that guides and condenses the light issued from the light source 12 (which is hereinafter sometimes referred to as the exciting light), the probe chip 16 that holds a liquid sample (to be measured) 82 that contains analytes 84 and into which the light condensed by the optical unit for incident light 14 is launched, a light detecting means 18 for detecting the light being issued from a measurement position on the probe chip 16, and a computing means 20 which, on the basis of the result of detection by the light detecting means 18, detects the analytes 84 (namely, digitizes the signal as detected by the light detecting means 18, checks for the presence of the analytes, and determines their concentration if they are present); having this construction, the sensing apparatus 10 detects (and measures) the analytes 84 contained in the liquid sample 82.

The sensing apparatus 10 further includes a function generator (hereinafter abbreviated as FG) 24 for modulating the exciting light, and a light source driver 26 by means of which an electric current proportional to the voltage generated in the FG 24 is flowed into the light source 12.

The FG 24 is a signal generator that generates repeating clocks at high and low voltages. When the FG 24 causes a signal to flow into the light source driver 26 which then supplies the light source 12 with an electric current proportional to the generated voltage, the light source 12 emits light as modulated in accordance with the clocks. The clocks from the FG 24 are inputted to a lock-in amplifier 64 which in turn picks up only the signal that is synchronous with the clocks from an output of the light detecting means 18.

Although not shown, all parts of the sensing apparatus 10 other than the probe chip 16 are also supported by support mechanisms to fix their relative positions.

The light source 12 is a light issuing device that issues light of a specified wavelength. The light issuing device may be of various types including a semiconductor laser, an LED, a lamp, and an SLD.

The optical unit for incident light 14 comprises a collimator lens 30, a cylindrical lens 32, and a polarizing filter 34, which are inserted into the optical path of the exciting light and arranged in that order, with the collimator lens 30 being the closest to the light source 12. Hence, the light issued from the light source 12 passes through the collimator lens 30, cylindrical lens 32, and polarizing filter 34 in that order and is then launched into the probe chip 16.

The collimator lens 30 is a device by which the light that is issued from the light source 12 to diffuse radially through a specified angle is converted to parallel light.

As shown in FIGS. 2A and 2B, the cylindrical lens 32 is a columnar lens whose axis extends parallel to the length of the channel in the probe chip which will be described later; by means of this lens, the light that has been rendered parallel by passage through the collimator lens 30 is condensed to focus on only a plane normal to the axis of the column (a plane parallel to the paper on which FIG. 2B is drawn).

The polarizing filter 34 is one by which the light passing through it is P-polarized with respect to the reflecting surface of the probe chip 16 which will be described later.

As regards the probe chip 16, it comprises a prism 38, a metal film 40, a substrate 42, and a transparent cover 44; the metal film 40 is formed on one surface of the prism 38 and a liquid sample 82 containing the analytes 84 is placed on top of the metal film 40.

The prism 38 is generally in the form of a triangular prism with a cross section shaped like an isosceles triangle (to be more exact, the prism is in the form of a hexagonal cylinder as obtained by cutting off the apices of the isosceles triangle in cross section through a plane either normal or parallel to the base of the isosceles triangle); this prism is placed in the optical path of the light that is issued from the light source 12 to be condensed by the optical unit for incident light 14.

The prism 38 is positioned in such a way that the light condensed by the optical unit for incident light 14 is incident on one of three sides that is defined by one of the two oblique sides of the isosceles triangle.

The prism 38 may be formed of a known transparent resin or optical glass; for example, it may be formed of ZEONEX® 330R (n=1.50; product of ZEON CORPORATION). However, in order to reduce the production cost, it is preferred to form the prism 38 of resins rather than optical glass; exemplary resins that may be used include polymethyl methacrylate (PMMA), polycarbonates (PC), and amorphous polyolefins (APO) containing cycloolefin.

Having this construction, the prism 38 allows the light condensed by the optical unit for incident light 14 to be incident on the surface that is defined by one of the two oblique sides of the isosceles triangle, the incident light being then reflected by the surface that is defined by the base of the isosceles triangle and emerging from the surface that is defined by the other of the two oblique sides of the isosceles triangle.

The metal film 40 is a thin metal film that is formed on part of that surface of the prism 38 which is defined by the base of the isosceles triangle (the part is specifically an area that includes the area that is irradiated with the light incident on the prism 38).

The metal film 40 may be formed of metals including Au, Ag, Cu, Pt, Ni and Al. In order to suppress its reaction with the liquid sample, Au or Pt is preferably used.

The metal film 40 may be formed by a variety of methods; for example, it may be formed on the prism 38 by sputtering, evaporation, plating, or pasting.

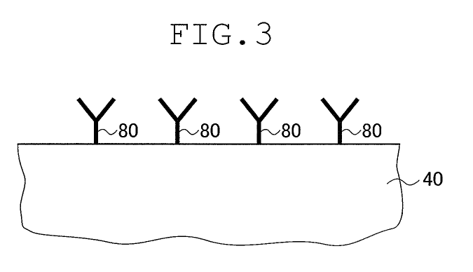

FIG. 3 is an enlarged schematic view showing enlarged a part of the metal film 40 on the probe chip 16 that is shown in FIGS. 2A and 2B.

As shown in FIG. 3, the metal film 40 has a plurality of primary antibodies 80 fixed to its surface as specifically binding materials that specifically bind to the analytes 84.

The substrate 42 is a member in plate form that is provided on the surface of the prism 38 that is defined by the base of the isosceles triangle and, as shown in FIG. 2A, it has a channel 45 formed in its surface as a passage for feeding the liquid sample 82 to the metal film 40.

The channel 45 consists of a straight linear portion 46 formed across and beyond the metal film 40, a beginning end portion 47 that is formed at one end of the linear portion 46 and serves as a liquid reservoir into which the liquid sample 82 is fed during measurement, and a terminal end portion 48 that is formed at the other end of the linear portion 46 to serve as a liquid reservoir that is reached by the liquid sample 82 that has passed through the linear portion 46 after being fed into the beginning end portion 47.

That part of the linear portion 46 which is closer to the beginning end portion 47 than the metal film 40 is provided with a secondary antibody placement area 49 where secondary antibodies 88 labeled with a fluorescent material 86 are placed.

The secondary antibodies 88 are each a specifically binding material that specifically binds to the analyte 84.

The transparent cover 44 is a transparent member in plate form that is joined to that surface of the substrate 42 which is away from the surface in contact with the prism 38. By closing that surface of the substrate 42 which is away from the surface in contact with the prism 38, the transparent cover 44 seals the channel 45 formed in the substrate 42.

The transparent cover 44 has two openings formed in it, one in the area that corresponds to the beginning end portion 47 of the channel 45 and the other in the area that corresponds to its terminal end portion 48. If desired, the opening formed in the position that corresponds to the beginning end portion 47 (as well as the opening formed in the position that corresponds to the terminal end portion 48) may be provided with a lid that can be opened or closed.

Described above is the construction of the probe chip 16. It should be noted here that the prism 38 as well as the metal film 40 and the substrate 42 are preferably formed monolithically.

The light source 12, the optical unit for incident light 14 and the probe chip 16 are arranged in such relative positions that the light issued from the optical unit 14 to be incident on the prism 38 is totally reflected by the boundary surface between the prism 38 and the metal film 40 to emerge from the other surface of the prism 38.

The light detecting means 18 comprises an optical unit for detecting light 50, a photodiode (hereinafter PD) 52 and a photodiode amplifier (hereinafter PD amp) 54, and it detects light as it emerges from the neighborhood of the metal film 40 in the probe chip 16 (namely, from the neighborhood of its surface).

The optical unit for detecting light 50 comprises a first lens 56, a cut-off filter 58, a second lens 60, and a support member 62 that supports these members; it condenses the light emerging from the surface of the metal film 40 (namely, the light emitted on the metal film 40) and allows it to be launched into the PD 52. In the optical unit for detecting light 50, the first lens 56, the cut-off filter 58 and the second lens 60, as spaced from each other, are arranged in that order in the optical path of the light emitted on the metal film 40, with the first lens 56 being the closest to the metal film 40.

The first lens 56 is a collimator lens provided in a face-to-face relationship with the metal film 40; it renders parallel the light that has reached it after being emitted on the metal film 40.

The cut-off filter 58 has such a characteristic that it selectively cuts off a light component that has the same wavelength as the exciting light but transmits light components having different wavelengths than the exciting light (e.g., fluorescence originating from the fluorescent material 86); thus, the cut-off filter 58 allows passage of only those portions of the collimated light from the first lens 56 that have different wavelengths than the exciting light.

The second lens 60 is a condenser lens which condenses the light passing through the cut-off filter 58 and allows it to be launched into the PD 52.

The support member 62 is a holding member that holds the first lens 56, the cut-off filter 58 and the second lens 60 monolithically as they are spaced from each other.

The PD 52 is an optical detector that converts received light to an electric signal; the light that has been condensed by the second lens 60 and launched into the PD 52 is converted to an electric signal. The PD 52 sends the electric signal (the first detection signal P0 or the second detection signal P to be described later) to the PD amp 54 as a detection signal.

The PD amp 54 is an amplifier that amplifies detection signals, so it amplifies the detection signal coming from the PD 52 and sends the amplified detection signal to the computing means 20.

Comprising a lock-in amp 64 and a PC (e.g., an arithmetic section) 66, the computing means 20 computes the mass of the analytes, their concentration and the like from the detection signal.

The lock-in amp 64 is an amplifier that amplifies that component of the detection signal which has the same frequency as a reference signal, so it amplifies that component of the detection signal as amplified by the PD amp 54 which is synchronous with the reference signal sent from the FG 24. The detection signal amplified by the lock-in amp 64 is run (outputted) into the PC 66.

The detection signal fed into the PC 66 from the lock-in amp 64 is converted to a digital signal, based on which the PC 66 detects the concentration of the analytes in the sample. The concentration of the analytes in the sample can be computed from the relationship between the number of analytes and the liquid volume. The number of analytes can be computed from a calibration line that is constructed on the basis of the relationship between the intensity of the detection signal and the number of analytes as computed using a known number of analytes. Note that by feeding a constant liquid volume of the sample to the channel 45 in the substrate 42 of the probe chip 16 (or designing the probe chip 16 such that a constant liquid volume of the sample will be fed), the concentration of the analytes can be computed in an easy but correct way.

Described above is the basic construction of the sensing apparatus 10.

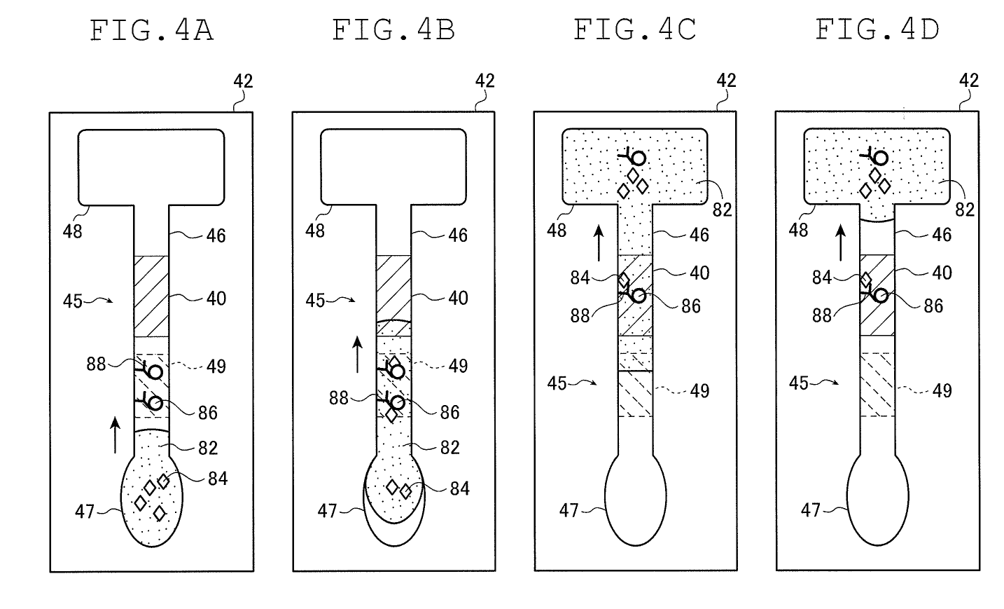

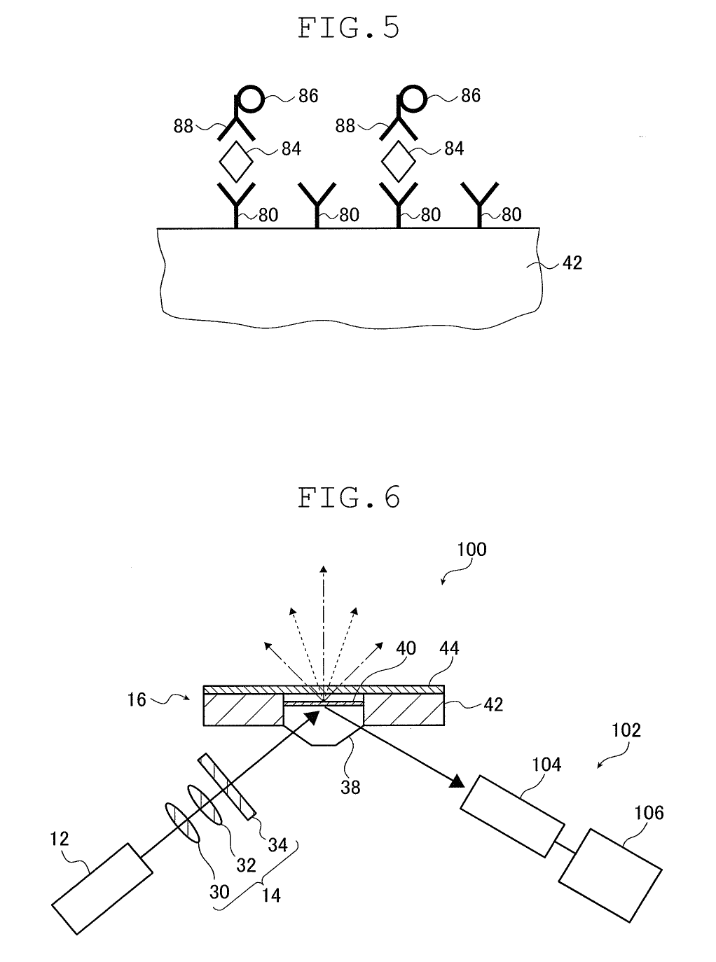

The present invention will be described below in greater detail by describing the action of the sensing apparatus 10. FIGS. 4A to 4D illustrate how the liquid sample 82 flows in the probe chip 16, and FIG. 5 is an enlarged schematic view showing enlarged a part of the metal film 40 with the liquid sample 82 having reached it.

First, the sensing apparatus 10 allows the light source 12 to issue the exciting light so as to create an enhanced electric field on the metal film 40 (to be more exact, an electric field that has been enhanced by surface plasmons and surface plasmon resonance) and, then, the light issued from the neighborhood of the metal film 40 is detected by the light detecting means 18 to acquire the detection signal P0.

The detection signal P0 is a signal obtained by the light detecting means 18 that has received the light issued from the surface of the metal film 40 to which neither the analytes nor the fluorescent material has attached and which is in a dry state (i.e., no liquid has attached to it) and it is a background signal that is free of the fluorescence from the fluorescent material 86. A specific method of acquiring the detection signal will be described later in detail.

Subsequently, as shown in FIG. A, the liquid sample 82 containing the analytes 84 is dripped in the beginning end portion 47 of the channel 45 in the substrate 42 of the probe chip 16.

The liquid sample 82 that has been dripped in the beginning end portion 47 starts to move towards the terminal end portion 48 through the tube defined by the linear portion 46 and the transparent cover 44 since it is shaped like a capillary tube.

The liquid sample 82 moving from the beginning end portion 47 through the linear portion 46 towards the terminal end portion 48 will reach the secondary antibody placement area 49 of the linear portion 46, as shown in FIG. 4B. When the liquid sample 82 reaches the secondary antibody placement area 49, the analytes 84 contained in the liquid sample 82 enter into an antigen-antibody reaction with the secondary antibodies 88 placed in the secondary antibody placement area 49, whereupon the analytes 84 bind to the secondary antibodies 88. Since the secondary antibodies 88 have been labeled with the fluorescent material 86, the analytes 84 that have bound to the secondary antibodies 88 become labeled with the fluorescent material 86.

The liquid sample 82 that has crossed the secondary antibody placement area 49 keeps moving through the linear portion 46 towards the terminal end portion 48 and it reaches the metal film 40. When the liquid sample 82 has reached the metal film 40, the analytes 84 contained in the liquid sample 82 enter into an antigen-antibody reaction with the primary antibodies 80 fixed on the metal film 40, whereupon the analytes 84 are captured by the primary antibodies 80 (see FIG. 5). Since the analytes 84 captured by the primary antibodies 80 have already been labeled with the fluorescent material 86 in the secondary antibody placement area 49, the primary antibodies 80 that have captured the analytes 84 become labeled with the fluorescent material 86. In other words, the analyte 84 becomes sandwiched between the primary antibody 80 and the secondary antibody 88.

The liquid sample 82 that has crossed the metal film 40 moves down to the terminal end portion 48. In addition, both the analytes 84 that have not been captured by the primary antibodies 80 and the secondary antibodies 88 that have not bound to the analytes 84, as well as the fluorescent material 86 labeling the secondary antibodies 88 also move down to the terminal end portion 48 together with the liquid sample 82.

As shown in FIG. 4C, this leaves on the metal film 40 the analyte 84 that has bound to the secondary antibody 88, that is labeled with the fluorescent material 86 and that has been captured by the primary antibody 80.

Thereafter, the liquid sample 82 further moves toward the terminal end portion 48 until most of it is in the terminal end portion 48 rather than the metal film 40, as shown in FIG. 4D. As a result, the metal film 40, whose surface is in such a state that it is free of a liquid (i.e., it is dry), has left on it the analyte 84 that is labeled with the fluorescent material 86 and which has been captured by the primary antibody 80.

When the surface of the metal film 40 has become dry and if the analytes 84 labeled with the fluorescent material 86 have been left on the surface of the metal film 40, the sensing apparatus 10 causes the exciting light to be issued from the light source 12 so as to generate surface plasmons on the metal film 40 and, then, the light being issued from the surface of the metal film 40 is detected by the light detecting means 18 to acquire the detection signal P.

The detection signal P is a signal obtained by the light detecting means 18 that has received the light issued from the surface of the metal film 40 where the analytes 84 labeled by the labeled secondary antibodies have been captured by the first antibodies 80 on the surface and it is a signal that contains the fluorescence originating from the fluorescent material 86.

Let us now describe in detail the methods of acquiring the detection signals P0 and P.

Since the two detection signals P0 and P are acquired by the same method except for the state on the metal film 40 (specifically, whether it involves fluorescence originating from the fluorescent material 86 with which the analytes are labeled or not), the case of acquiring the detection signal P is taken as a representative example and described below.

To begin with, the light source 12 is caused to issue the exciting light based on the current flowing from the light source driver 26 in response to the intensity modulated signal as determined in the FG 24.

The exciting light issued from the light source 12 passes through the optical unit for incident light 14. Specifically, the exciting light is rendered parallel by the collimator lens 30, then condensed by the cylindrical lens 32 in only one direction, and is thereafter polarized by the polarizing filter 34.

The light passing through the optical unit 14 for incident light is launched into the prism 38, through which it travels as a beam having a specified angular range until it reaches the boundary surface between the prism 38 and the metal film 40; the light is then reflected totally by the boundary surface between the prism 38 and the metal film 40 to emerge from the prism 38. Note that the cylindrical lens 32 condenses the light in such a way that it is focused at a position a certain distance beyond the boundary surface between the prism 38 and the metal film 40.

As mentioned above, the parallel light generated by the collimator lens 30 is condensed by the cylindrical lens 32 in only one direction and this ensures that the exciting light has the same angle of incidence in a direction parallel to the direction in which the linear portion 46 extends across the boundary surface between the prism 38 and the metal film 40.

As the result of the total reflection of the exciting light that occurs at the boundary surface between the prism 38 and the metal film 40, an evanescent wave penetrates the metal film 40 to appear on the surface where the channel 45 is formed (opposite the surface in contact with the prism 38) and this evanescent wave excites surface plasmons in the metal film 40. The excited surface plasmons produce an electric field distribution on the surface of the metal film 40 to form an area having an enhanced electric field.

On this occasion, the evanescent wave and surface plasmons that have been generated by that portion of the exciting light incident at angles over a specified range which struck the boundary surface between the prism 38 and the metal film 40 at a specified angle (specifically, at the angle that satisfies the plasmon resonance condition) resonates with each other, causing surface plasmon resonance (the plasmon enhancing effect). In the area where this surface plasmon resonance (plasma enhancing effect) has occurred, a more intense enhancement of the electric field is realized. The plasmon resonance condition as referred to above is such a condition that the wavenumber of the evanescent wave generated by the incident light becomes equal to the wavenumber of surface plasmons to establish a wavenumber match. As already mentioned, this plasmon resonance condition depends on various factors including the type of the sample, its state, the thickness of the metal film, its density, the wavelength of the exciting light, and its incident angle. Also note that in the invention the plasmon resonance angle and the incident angle of the exciting light (each of its rays) are the angle it forms with the line normal to the surface of the metal film.

It should also be noted that if the fluorescent material 86 is present in the area where the evanescent wave has come out, it is excited to generate fluorescence. This fluorescence is enhanced by the effect for field enhancement of the surface plasmons that are present in an area substantially comparable to the area where the evanescent wave has come out, particularly by the effect for field enhancement that has been enhanced by the surface plasmon resonance.

Note that the fluorescent material that is outside the area where the evanescent wave has come out is not excited and hence does not generate fluorescence.

In this way, the fluorescence from the fluorescent material 86 with which the analytes 84 fixed on the metal film 40 are labeled is excited and enhanced.

The light issued from the fluorescent material 86 is incident on the first lens 56 in the light detecting means 18, passes through the cut-off filter 58, is condensed by the second lens 60, and is launched into the PD 52 where it is converted to an electric signal. Since that component of the light that is incident on the first lens 56 and which has the same wavelength as the exciting light cannot pass through the cut-off filter-58, the exciting light component does not reach as far as the PD 52.

The electric signal generated in the PD 52 is amplified as the detection signal P in the PD 54 and thence fed into the lock-in amp 64, which amplifies the signal component that is synchronous with the reference signal. As a result, the light generated on account of the exciting light can be sufficiently amplified so that any unwanted noise components (for example, the light that has been launched into the PD 52 other than from the optical unit for detecting light 50, as exemplified by the light from fluorescent lamps in a room or the light from sensors in the apparatus, as well as the dark current generated in the PD 52) can be positively distinguished from the light issued from the fluorescent material 86.

The detection signal P as amplified by the lock-in amp 64 is sent to the PC 66.

This is the way the detection signal P is acquired. As already mentioned, the detection signal P0 is acquired by essentially the same method.

Using the thus acquired detection signals P0 and P, the PC 66 performs baseline subtraction (specifically, computes a difference Δ=P−P0) and computes the signal that originates from the fluorescent material but from which the background has been removed.

The PC 66 performs A/D conversion on the signal, and based on a preliminarily stored calibration line, it detects the concentration of the analytes 84 in the liquid sample 82 from the result of computation about the analyte 84.

In the manner described above, the sensing apparatus 10 detects the mass and concentration of the analytes 84 in the liquid sample 82.

In the sensing apparatus 10, before the liquid sample 82 is dripped in the beginning end portion 47, both the detection signal P0 for the light that is being issued from the surface of the metal film 40 to which the fluorescent material 86 has not attached and the detection signal P for the light that is being issued from the surface of the metal film 40 on which the analytes 84 labeled with the labeled secondary antibodies have been captured by the primary antibodies 80 and which is in a dry state are acquired, and baseline subtraction is performed using the two detection signals P0 and P; as a result, noise can be appropriately removed and the fluorescence originating from the fluorescent material 86 with which the analytes 84 are labeled can be detected more accurately.

In concrete terms, the sensing apparatus 10 detects the background signal with the metal film 40 being in a dry state and, in addition, the fluorescence signal originating from the analytes 84 labeled with the fluorescent material 86 is also detected with the metal film 40 being in a dry state; this ensures that the surface of the metal film 40 has the same refractive index whichever detection signal is being acquired. As a result, the plasmon resonance condition that is established in the case of acquiring the detection signal P0 is substantially the same as that in the case of acquiring the detection signal P and, hence, the background and the fluorescence originating from the fluorescent material can both be measured advantageously enough to achieve accurate noise removal.

As a further advantage, there is no need to provide a mechanism for changing the incident angle of the exciting light in accordance with variations in the plasmon-resonance angle, and this contributes to preventing the apparatus from becoming complex in configuration, bulky in size, and expensive.

Furthermore, acquiring the detection signals P0 and P with the metal film kept in a dry state assures more effective prevention of a departure from the plasmon resonance condition and, hence, more accurate noise detection and removal than when acquiring the detection signal P0 using a buffer solution. In addition, there is no need to provide a fresh liquid, so the apparatus can be simplified in configuration and made less expensive.

What is more, the background can be easily measured and noise removed for each probe chip; as a result, even the noise that changes with different probe chips can be accurately detected and the permissible errors in the probe chip can be made great enough to enable the manufacture of probe chips at lower cost.

It should be noted here that since the liquid sample 82 in the channel 45 moves toward the terminal end portion 48, the probe chip 16 in the sensing apparatus 10 has such an advantage that by performing detection when a specified setup time has lapsed after the liquid sample was dripped in the beginning end portion 47, the light being emitted from the surface of the metal film in a dry state can be detected. The setup time referred to above is the time that it takes for the liquid sample to disappear from the metal film and can be computed by preliminary experimentation with probe chips of identical shape.

In a preferred embodiment, the sensing apparatus has a dryness detecting means for checking to see if the surface of the metal film is in a dry state.

The dryness detecting means is hereunder described with reference to FIG. 6.

FIG. 6 is a block diagram showing a general construction of part of a sensing apparatus having the dryness detecting means which is another embodiment of the sensing apparatus of the present invention. Note that the sensing apparatus 100 shown in FIG. 6 is of the same construction as the sensing apparatus 10 except that it has the dryness detecting means 102; hence, like parts and structural features are identified by like numerals and will not be described in detail.

As shown in FIG. 6, the sensing apparatus 100 has a light source 12, an optical unit for incident light 14, a probe chip 16, and the dryness detecting means 102. Although not shown, the sensing apparatus 100, like the sensing apparatus 10, also has a light detecting means, a computing means, an FG, and a light source driver.

The dryness detecting means 102 has a second photodiode (hereinafter sometimes referred to as a second PD) 104 that is provided in the optical path of that component of the exciting light issued from the light source 12 to pass through the optical unit for incident light 14 to be launched into the probe chip 16 which is totally reflected at the boundary surface between the prism 38 and the metal film 40 to emerge from the prism 38 and which receives and detects the light as it emerges from the prism 38, as well as an evaluating section 106 that detects the intensity distribution of the light detected in the second PD and which determines whether the surface of the metal film is dry or not on the basis of the result of the detection.

As just described above, the second PD 104 is provided in the optical path of the light totally reflected at the boundary surface between the prism 38 and the metal film 40 to emerge from the prism 38 (i.e., the reflected light) and it receives this reflected light. The second PD 104 sends the detected reflected light to the evaluating section 106 as a detection signal.

The evaluating section 106 determines whether the surface of the metal film 40 is dry or not on the basis of the detection signal sent from the second PD 104.

Here, the sensing apparatus 100 is so set that the exciting light is incident at the plasmon resonance angle, or the angle at which the plasmon enhancing effect (specifically, the surface plasmon resonance) materializes on the metal film 40 whose surface is in a dry state. As already mentioned, the plasmon resonance angle varies greatly depending on whether the liquid sample is on the metal film 40 (it is in a wet state) or not (the metal film 40 is in a dry state).

Hence, the sensing apparatus 100 does not generate the plasmon enhancing effect when the metal film 40 is in a wet state.

It should also be noted that the reflected light as detected by the second PD 104, which has been totally reflected at the boundary surface between the prism 38 and the metal film 40, has basically the same intensity distribution as the exciting light (namely, an intensity distribution that is basically the same as that of the light being issued from the light source); however, as already mentioned, if surface plasmon resonance occurs on the metal film 40, that component of the exciting light that is incident at the plasmon resonance angle is converted to surface plasmons, so the component of reflected light that corresponds to the plasmon resonance angle of the exciting light is greatly reduced.

Therefore, the sensing apparatus 100 is such that only when the metal film 40 is dry does the plasmon enhancing effect occurs to cause a considerable decrease in the component of light for a specified angle.

Relying upon these characteristics of the reflected light, the evaluating section 106 determines that the surface of the metal film 40 is wet if the intensity component of the detection signal as acquired by the second PD 104 for the angle that originates from the plasmon resonance angle is greater than a specified value while it determines that the surface of the metal film 40 is dry if that intensity component is equal to or less than the specified value.

The light detecting means 18 acquires the detection signal P after the dryness detecting means 102 has determined that the surface of the metal film 40 is dry.

As described above, the dryness detecting section 102 depends on the reflected light for detecting the dry state of the surface of the metal film, and if the liquid remains on part of the metal film after the lapse of the setup time, it is correctly evaluated as being not dry and, hence, the surface state of the metal film can be detected more accurately. Thus, the analytes can be detected, with an enhanced electric field being positively created on the surface of the metal film as it has been enhanced by surface plasmons and surface plasmon resonance; this enables more positive and accurate detection of the analytes.

The ability to detect the dryness of the surface of the metal film ensures that the detection signal P can be acquired as soon as the surface of the metal film has become dry. This enables the analytes to be detected within a short period of time.

In yet another preferred embodiment, the sensing apparatus may be provided with a drying accelerating means for drying the metal film in a shorter period of time.

By providing the drying accelerating means, the surface of the metal film can be dried within a shorter period of time and the analytes contained in the liquid sample can be detected within a short enough period of time.

Here, the drying accelerating means may be exemplified by a heating means for heating the surface of the metal film or a suction means for aspirating the liquid sample in the channel through which the liquid sample is fed to the surface of the metal film.

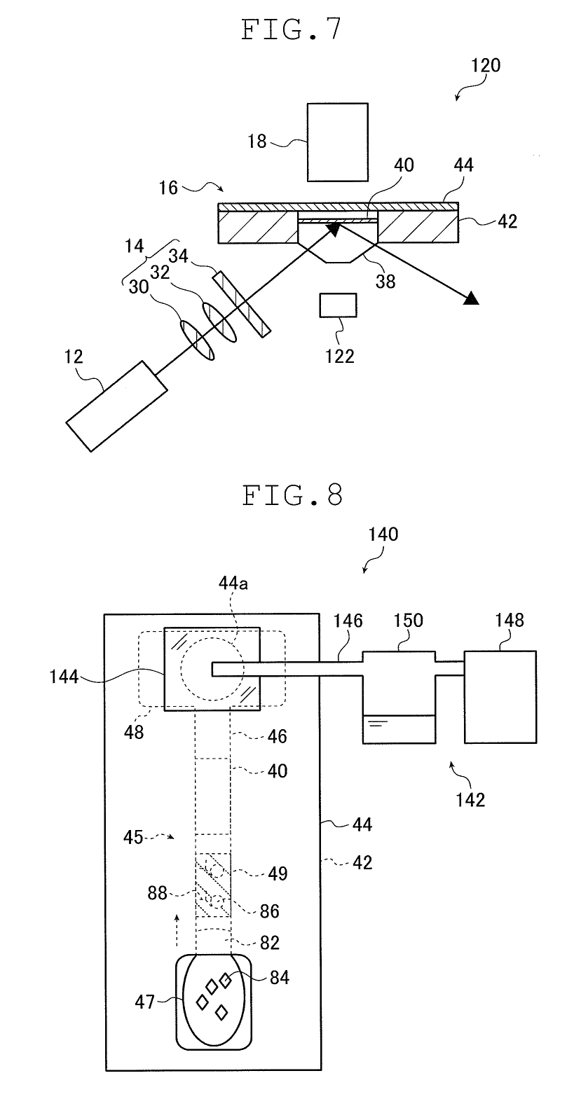

FIG. 7 is a block diagram showing a general construction of part of a sensing apparatus 120 having a heating means 122 which is yet another embodiment of the sensing apparatus of the present invention.

Note that the sensing apparatus 120 shown in FIG. 7 is of the same construction as the sensing apparatus 10 except that it has the heating means 122; hence, like parts and structural features are identified by like numerals and will not be described in detail.

As shown in FIG. 7, the sensing apparatus 120 has a light source 12, an optical unit for incident light 14, a probe chip 16, a light detecting means 18, and the heating means 122. Although not shown, the sensing apparatus 120, like the sensing apparatus 10, also has a computing means, an FG, and a light source driver.

The heating means 122 is provided in a face-to-face relationship with and a specified distance from the probe chip 16 on the side away from the light detecting means 18 such that it heats the metal film 40 from the side where the prism 38 is provided.

Here, a variety of heating devices can be used as the heating means 122 and they include a carbon heater, a lamp heater, etc. Note that the heating means 122 preferably heats the metal film at such temperatures that the prism 38, the metal film 40, the fluorescent material and the like will not be deteriorated.

Heating the metal film 40 by the heating means 122 allows the liquid sample on the metal film 40 to evaporate so that the surface of the metal film 40 can be rendered dry within a shorter period of time.

Thus, by providing the heating means 122, the surface of the metal film can be dried more quickly than by air-drying and, hence, the analytes can be detected in a shorter period of time.

Next, FIG. 8 is a block diagram showing a general construction of part of a sensing apparatus having a suction means which is still another embodiment of the sensing apparatus of the present invention.

Note that the sensing apparatus 140 shown in FIG. 8 is of the same construction as the sensing apparatus 10 except that it has the suction means 142; hence, like parts and structural features are identified by like numerals and will not be described in detail.

As shown in FIG. 8, the sensing apparatus 140 has a probe chip 16 and the suction means 142. Although not shown, the sensing apparatus 140, like the sensing apparatus 10, also has a light source, an optical unit for incident light, a light detecting means, a computing means, an FG, and a light source driver.

The suction means 142 has a joining member 144 that is formed in correspondence with the terminal end portion 48 such that it joins to an opening 44a in the transparent cover 44, a tube 146 connected to the joining member 144, a pump 148 connected to the joining member 144 via the tube 146, and a liquid waste tank 150 provided on part of the tube 146; having this structure, the suction means 142 applies suction to the channel 45 so as to aspirate the liquid sample within the channel 45.

The joining member 144 is a plate that is provided across and beyond the opening 44a in the transparent cover 44 so as to close it completely. Note that the joining member 144 can be formed of various materials and, in the embodiment under consideration, it is formed of PDMS (polydimethyl siloxane).

The tube 146 is a tubular member which is connected to the joining member 144 at one end and connected to the pump 148 at the other end.

The pump 148 is a suction pump which is connected to the tube 146. By way of the tube 146, the pump 148 aspirates the air in the terminal end portion 48 through the opening 44a in the transparent cover 44 connected to the joining member 144 so that the liquid sample in the terminal end portion 48 and the linear portion 46 is sucked into the tube 146.

The liquid waste tank 150, being provided on part of the tube 146, serves as a reservoir of the liquid sample aspirated from the terminal end portion 48 by means of the pump 148.

Having this structure, the suction means 142 is capable of drying the surface of the metal film within a short period of time by using the pump 148 to aspirate the liquid sample in the channel 45 so that it quickly flows out of the terminal end portion 48 to ensure that the surface of the metal film is dried within a short period of time. As a further advantage, the air within the channel 45 is aspirated together with the liquid sample and, hence, any residual liquid sample on the metal film 40 can be evaporated quickly enough to ensure that the metal film 40 is dried within a short period of time.

It should also be noted that the suction means is by no means limited to the structure described above and a variety of suction means capable of aspirating liquid samples may be employed, as exemplified by a syringe pump.

While the sensing apparatus and the substance detecting method according to the present invention have been described above in detail, the present invention is by no means limited to the foregoing embodiments and it should be understood that various improvements and modifications are possible without departing from the scope and spirit of the present invention.

In each of the foregoing embodiments, the optical unit for incident light comprises a collimator lens and a cylindrical lens as a condenser lens, and the light issued from the light source is made parallel by passage through the collimator lens and then condensed by the cylindrical lens; this is not the sole case of the present invention and only a condenser lens may be provided so that the light issued from the light source is not made parallel but is simply condensed by the condenser lens.

In the sensing apparatus 10, the optical unit for incident light uses a cylindrical lens or a condenser lens to condense the light issued from the light source; this is not the sole case of the present invention and the light issued at a specified angle of radiation from the light source need not be condensed but it may simply be caused to strike the boundary surface between the prism and the metal film.

There is also no absolute need to provide the polarizing filter and this is particularly true in the case of using a laser light source because the light issued from the laser is already polarized.

In the embodiments described above, the secondary antibodies labeled with the fluorescent material are placed in the secondary antibody placement area; this is not the sole case of the present invention and the secondary antibody placement area need not be provided but the liquid sample to be dripped in the beginning end portion may be such that the analytes are preliminarily labeled with the fluorescent material.

The detection signal P0 may be acquired at any time that precedes the arrival of the liquid sample at the metal film and, in an exemplary case, the detection signal P0 may be acquired while the liquid sample is moving through the linear portion of the channel.

In the embodiments described above, the channel is formed in the probe chip and the liquid sample is brought into contact with the metal film by causing it to move from the beginning end portion through the linear portion to the terminal end portion; this is not the sole case of the present invention and the shape of the probe chip is not particularly limited. An exemplary structure is such that no channel is provided in the probe chip but the liquid sample is directly dripped on the metal film.

In each of the foregoing embodiments, the number or concentration of the analytes contained in the liquid sample is detected but this is not the sole case of the present invention and one may check to see if the liquid sample contains the analytes or not (i.e., if the analytes are in the liquid sample or not).

In each of the foregoing embodiments, the analytes are detected by detecting the fluorescence from the fluorescent material as excited by surface plasmons, with the analytes being bound to the secondary antibodies labeled with the fluorescent material; the method of labeling the analytes with the fluorescent material is not particularly limited and there is no need to provide secondary antibodies if the analytes themselves are the fluorescent material.

The sensing apparatus of the present invention may also be adapted to detect scattered light (Raman scattered light) that occurs when surface plasmons are generated on the metal film as it has the analytes attached thereto (or positioned in its neighborhood).

In each of the foregoing embodiments, an evanescent wave and surface plasmons are generated on the surface of the metal film and, furthermore, surface plasmon resonance is generated to form an enhanced electric field; however, this is not the sole case of the present invention and it may be applied to various approaches in which the intensity of enhancement varies with the angle of incidence of light on the surface where the enhanced electric field is to be formed (namely, the enhanced field varies only when light is incident at a specified angle). For example, the present invention is applicable to such an approach that a metal film and a SiO₂ film about 1 μm thick are superposed on the prism and that light incident at a specified angle is resonated within the SiO₂ film to thereby form an enhanced electric field.

In each of the foregoing embodiments, the exciting light is launched into the optical unit for incident light such that it makes total reflection at the boundary surface in order to ensure that an enhanced field is advantageously created by surface plasmons; however, this is not the sole case of the present invention and the exciting light may be launched at such angles that no total reflection will occur.

What is claimed is:

1. A sensing apparatus for detecting an analyte in a liquid sample with an aid of an enhanced field that is generated by causing light to strike a detection surface at a specified angle of incidence, comprising:
a prism;
a metal film provided on a surface of the prism and which has provided on its surface a material that binds to the analyte;
a substrate that is provided on a surface of the prism and which has formed therein a channel for supplying the liquid sample to the metal film;
a light source for issuing light;
an optical unit for incident light by which the light issued from the light source is launched into the prism at a specified angle;
a light detecting means for detecting as a first detection signal the light being generated in neighborhood of the metal film before the liquid sample is supplied and for detecting as a second detection signal the light being generated in neighborhood of the metal film that has become dry after the liquid sample is supplied; and
an analyte detection means for detecting the analyte contained in the liquid sample based on a difference between the first and the second detection signals detected by the light detecting means.

2. The sensing apparatus according to claim 1, wherein the analyte is one of a fluorescent material and a material that is labeled with a fluorescent material during detection.

3. The sensing apparatus according to claim 1, further comprising a heating means for heating the metal film.

4. The sensing apparatus according to claim 1, further comprising a suction means that aspirates the liquid sample in the channel.

5. The sensing apparatus according to claim 1, further comprising a dryness detecting means that checks to see if the metal film is dry or not.

6. The sensing apparatus according to claim 5, wherein the optical unit for incident light causes the light issued from the light source to be launched into the prism at such an angle that it is totally reflected on the boundary surface between the prism and the metal film, and
wherein the dryness detecting means has a mechanism that receives rays of light emerging from the prism to detect either the presence or absence of surface plasmon resonance at the boundary surface, and that determines from the result of detection as to whether the metal film is dry or not.

7. The sensing apparatus according to claim 1, wherein the analyte detection means detects the concentration of the analyte in the liquid sample.

8. A method of detecting substances comprising:
a metal film providing step in which a metal film having on a surface thereof a specifically binding material that specifically binds to an analyte is provided;
a first light-detecting step in which when another surface of the metal film is irradiated with light at a specified angle of incidence as the surface of the metal film is not in contact with a liquid sample so as to generate an enhanced field on the surface of the metal film, the light being generated in neighborhood of the surface of the metal film is detected as a first detection signal;
a liquid sample feeding step in which the liquid sample is allowed to pass over the metal film so that the surface of the metal film is brought into contact with the liquid sample;
a second light-detecting step in which when another surface of the metal film is irradiated with light at the specified angle of incidence as the surface of the metal film has become dry after it was contacted by the liquid sample so as to generate an enhanced field on the surface of the metal film, the light being generated in neighborhood of the surface of the metal film is detected as a second detection signal; and
a substance detecting step in which the analyte in the liquid sample is detected from the difference between the first detection signal and the second detection signal.

9. The method of detecting substances according to claim 8, wherein the substance detecting step is performed such that the concentration of the analyte in the liquid sample is computed from the difference between the first detection signal and the second detection signal.

10. The method of detecting substances according to claim 8, further includes:
a dryness detecting step in which the surface of the metal film is detected for dryness after the surface of the metal film has been brought into contact with the liquid sample in the liquid sample feeding step; and
the second light detecting step is performed such that the second detection signal is detected after the surface of the metal film has been found to be in a dry state in the dryness detecting step.
